(19) United States
(12) Patent Application Publication
(10) Pub. No.: US 2016/0312550 A1
(43) Pub. Date: Oct. 27, 2016

(54) Multi-Bolt or Nut Torque Wrench Device for Installing or Removing A Plurality of Threaded Bolt or Nut Members

(71) Applicant: HYTORC NORGE AS, Sola (NO)

(72) Inventor: Knut Jonassen, Sola (NO)

(73) Assignee: HYTORC NORGE AS, Sola (NO)

(21) Appl. No.: 15/103,493

(22) PCT Filed: Dec. 15, 2014
(86) PCT No.: PCT/NO2014/050235

§ 371 Date: Jun. 10, 2016

(30) Foreign Application Priority Data
Dec. 19, 2013 (NO) 20131713

(51) Int. Cl. E21B 19/16; E21B 17/04; E21B 17/01; B25B 21/00; B23P 19/06

(52) U.S. Cl. CPC E21B 19/16; B25B 21/002; B23P 19/061; B23P 19/069; E21B 17/01; E21B 17/04

(57) ABSTRACT

The invention relates to a multi-bolt or nut torque wrench device (10, 10a, 10b) for installing or removing a plurality of threaded bolt or nut members (150). The device includes a reaction plate (20), a plurality of torque stations (30) mechanically coupled to the reaction plate (20) and configured for receiving one of the bolt or nut members (150) in operational use. In operational use, each torque station (30) applies reaction force directly and only to the reaction plate (20), and in that the reaction plate (20) and plurality of torque stations (30) are configured to be located substantially at an upper side of a respective flange (110) of a part to be coupled or decoupled from a part (100) in operational use, such that the torque wrench device (10, 10a, 10b) is configured for resting substantially on the plurality of threaded bolt or nut members (150) in operational use.

The invention relates to a multi-bolt or nut torque wrench device for installing or removing a plurality of threaded bolt or nut members on a riser of a rig.

In the makeup or break down of large structures, such as, for example rig risers, the sections of the riser are flanged together with bolts threadably engaging the flanges on the end of each section, and made up very tightly to complete the structure. There are numerous other types of structures which use this same system of makeup, i.e., very large bolts through flanges connecting sections of structures.

Flanged riser joints use specially designed bolts that must be torqued to a precise pre-load. Typically, flanged riser connectors in the offshore drilling industry use six (6) bolt flanges with each bolt straddling an auxiliary line position. During the operation of running the blow out preventer or “BOP” (e.g., initially installing the BOP and riser), an upper flange of a riser joint in the riser string can be landed and supported on the riser spider (e.g., with the spider dogs in an extended state). A new riser joint can be stabbed or placed on top of the supported riser joint and the plurality of riser bolts can be turned down and torqued thereby making up the connection. This process can be repeated as many times as needed until the riser string reaches the sea floor and can be attached to the wellhead.

In a typical rig riser structure the flanged sections of the risers include six (6) holes radially spaced apart in about 60-degree increments (around the 360-degree bolt circle of the riser section flanges). The riser string typically extends from the drilling rig above the surface of the water to the wellhead located at sea floor. In deepwater installations the depth of water typically exceeds 5,000 feet. Riser sections are typically provided in 75 foot lengths, yielding a minimum of 67 riser sections or joints and 67 multiplied by 6 (or 402) bolts which must be properly tightened or made up (when installing the riser) or loosened or broken out (when removing the riser).

Presently, when installing or removing riser sections or joints, torque wrenches are manually positioned and operated to individually tighten or loosen each of the six bolts for each riser section or joint. In an effort to speed up the process two torque wrenches operated by two operators can be used addressing two bolts at the same time. However, each operator must individually position and operate his torque wrench on the head of each bolt when tightening or loosening. The operator continues around the flange until all six bolts have been torqued. Additionally, after completing each bolt, the operator must manually remove the torque wrench from the made up bolt and position the torque wrench on the next bolt. After all bolts are torqued down, the spider dogs are retracted and the riser string (e.g., plurality of riser joints and BOP) is lowered to allow the placement and make-up of the connection to the next riser joint section. It must be noted that there is quite some health-safety-environment (HSE) danger with the use of standard tools, because of the fact that several people have to be in the so called “Red Zone” (typically having a radius of 5 to 6 m around the riser) during the torque process. Furthermore, with the conventional tools there is the danger of serious injuries to the operators, because of the use of a reaction arm in these tools.

This manual process is time consuming and slows down both the initial installation along with the removal of the riser. Additionally, the operators of these torque wrenches can become tired slowing down the process, making mistakes, damaging equipment, and/or causing injury. Due to increasing rig day rates and improved HSE requirements, it is desirable to create a tool that can preload each riser flange connection quicker and without human presence at the well centre. This would improve rig operational efficiency as well as safety performance. In a typical yearly operation of a drilling rig the riser string can be retrieved (tripping out) and installed (tripping in) between two and twenty four times.

While certain novel features of this invention shown and described below are pointed out in the annexed claims, the invention is not intended to be limited to the details specified, since a person of ordinary skill in the relevant art will understand that various omissions, modifications, substitutions and changes in the forms and details of the device illustrated and in its operation may be made without departing in any way from the spirit of the present invention. No feature of the invention is critical or essential unless it is expressly stated as being “critical” or “essential.”

US2013/0186642A1 discloses an improved multi-bolt and nut torque wrench for installing and removing bolts or nuts from flanged joints or the like. The wrench comprises: i) a plurality of torque stations having a) a plurality of high torque wrenches for engaging the heads of the bolts or nuts during a high torque phase of removal or installation. The plurality of torque stations further comprise: b) a plurality of low-torque motors operatively engaged with the wrenches for rotating the bolts or nuts during the low torque phase of removal or installation. The wrench further comprises ii) a source of hydraulic fluid for driving the low-torque motors during the low-torque phase, and driving the high-torque wrenches during the high torque phase; and iii) a mechanism for switching between the two phases depending on the torque needed. During both high speed and high torque phases a reaction bar will provide the reaction force to counteract the reaction torque generated by either tightening or loosening the bolts. During operation a reaction torque (or force) equivalent to the torque applied by torque wrench will be generated when removing or tightening bolt. This reaction torque must be compensated for by having reaction bar transmit such torque to the structure of the rig and/or riser. The reaction torque from a bolt is transferred to a driver and wrench body to the reaction bar, and from the reaction bar to braces, to feet, to shafts, and to the base. The base is connected to a spider which itself can be connected to the floor of rig and such reaction torque is transferred to the floor of rig. The disadvantage of this multi-bolt and nut torque system is that it is very big, very bulky, very costly, and very heavy. Furthermore, it must be noted that the solution presented in US2013/0186642A1 actually requires a rebuilding of the drilling rig, which is quite a disadvantage.

The invention has for its object to remedy or to reduce at least one of the drawbacks of the prior art, or at least provide a useful alternative to prior art.

The object is achieved through features, which are specified in the description below and in the claims that follow.

In a first aspect the invention relates more particularly to a multi-bolt or nut torque wrench device for installing or removing a plurality of threaded bolt or nut members on a riser of a rig. The device comprises a reaction plate, and a plurality of torque stations mechanically coupled to the reaction plate and configured for receiving one of said bolt or nut members in operational use. In operational use, each torque station applies its reaction force directly and only to the reaction plate. Furthermore the reaction plate and said plurality of torque stations are configured to be located substantially at an upper side of a respective flange of a respective riser joint to be coupled or decoupled from a further riser joint in operational use, such that said torque wrench device is configured for resting substantially on said plurality of threaded bolt or nut members in operational use.

The effects of the combination of the features of the invention are as follows. The reaction plate, which now rests on the plurality of threaded bolt or nut members can be kept small, i.e. it only needs to fit around the riser, carry the plurality of torque stations, and be strong enough to allow the reaction forces of the torque stations to be applied thereto without breaking down. The reduced size of the device also leads to less bulkiness and therefore less costs and weight. Another great advantage of the torque wrench device of the invention is that it does not need any change to the rig, i.e. it is a plug-and-play solution.

In an embodiment of the device according to the invention each torque station comprises: i) a socket for receiving a respective bolt or nut member; ii) a tool drive mechanically coupled to the socket for driving the socket; iii) a wrench tool configured for torqueing the tool drive; iv) a spinner tool configured for spinning the tool drive, and v) an hydraulic interface for being coupled to a hydraulic controller for selecting one of said tools in operational use. The configuration here described is a very convenient one for forming a torque station that is suitable for being used in installing in or removing riser joints from a riser.

In an embodiment of the device according to the invention said wrench tool and said spinner tool are hydraulic tools. Hydraulic tools are very suitable for applying the high speeds and torques that are required in riser applications.

In an embodiment of the device according to the invention said wrench tool and said spinner tool are standard hydraulic tools, and preferably lightweight hydraulic tools. One of the great advantages of the invention is that the design and miniaturization has opened up the possibility to use standard hydraulic wrench and spinner tools for spinning and torqueing the bolt or nut members. When these compact hydraulic tools are used they may be provided such that their respective torque driving axes of operation coincide with the rotation axis of said bolt or nut members. The use of light-weight tools increases the portability and handability of the device to a large extent.

In an embodiment of the device according to the invention the wrench tool and the spinner tool are driven by independent hydraulic systems. The advantage is that the hydraulics for the wrench tool can be tailored to the special needs of the wrench tool.

In an embodiment of the device according to the invention the wrench tool is driven by an hydraulic system operating with a maximum pressure higher than 200 bar, and preferably higher than 500 bar, and even more preferably higher than 700 bar. When higher pressures are used, the size of the tools can be kept smaller at a certain desired torque.

In an embodiment of the device according to the invention said reaction plate comprises lightweight material, such as aluminium. The compact design of the invention has even opened up the possibility to use lightweight material for the reaction plate. Prototypes have been made using aluminium, which has proven to be strong enough.

In an embodiment of the device according to the invention the reaction plate is provided with a plurality of through-holes through which said torque stations extend and operate. One way of making a device in accordance with the invention is to make through-holes in the reaction plate through which said torque stations extend and operate. Such configuration provides for a very compact and lightweight solution. In an alternative embodiment of the invention the reaction plate does not necessarily have holes or indentations, but the respective torque stations are mounted such that they all extend inwardly with respect to the reaction plate which itself encircles at least part of the plurality of nuts and bolts.

In an embodiment of the device according to the invention has a respective torque driving axis of operation that coincides with the rotation axis of said respective bolt or nut member to which it is coupled in operational use. This configuration leads to a more compact solution.

In an embodiment of the device according to the invention the reaction plate is shaped to receive a riser within, preferably being further shaped for receiving a further pipe or pipes that run parallel to the riser. In principle there are many designs of the reaction plate possible. What is important, though, is that the reaction plate is designed to receive a riser within, or at least partially within, and that the respective torque stations are placed along the circumference of the reaction plate at locations compliant with the bolt or nut members on the flange of the riser. In one variant the torque wrench device of the invention comprises of two parts, with each their own reaction plate, each reaction plate carrying half of the torque stations. In another variant the two halves are mounted together in a hinging manner to form a openable enclosure around the riser. Nevertheless, it must be stressed that the invention is not restricted to any particular number of tool parts, as long as each tool part carries at two torque stations, so that a reaction arm can be dispensed with. For stability purposes three torque stations has been proven better.

In an embodiment of the device according to the invention the shape of the reaction plate includes a number of indentations having a size and location complying with said further pipe or pipes. Risers are typically accompanied by other tubular structures or pipes running parallel to it. By no means must one apply force to these auxiliary structures. The invention conveniently provides for the options to design around these structures by providing appropriate indentations in the reaction plate.

In an embodiment of the device according to the invention said torque wrench device is configured in size, shape and weight for being portable by humans. Even though the portability of the device has already been discussed in view of some of the embodiments, this embodiments covers all measures taken that are intended to increase the portability of the device. The facilitation of the portability of the device is considered one of the key advantages of the invention. The torque wrench device of the invention is not a permanent installation on a rig and does not form part of the rig.

In an embodiment of the device according to the invention the device is configured to be placed on top of the bolt or nut members, in operational use. The major advantage of this configuration is that it takes hardly more space than the enclosure of the reaction plate. Furthermore, when the device rests on the bolt or nut members it will automatically follow the bolt or nut members as it is spinning them.

In the following is described an example of a preferred embodiment illustrated in the accompanying drawings, wherein:

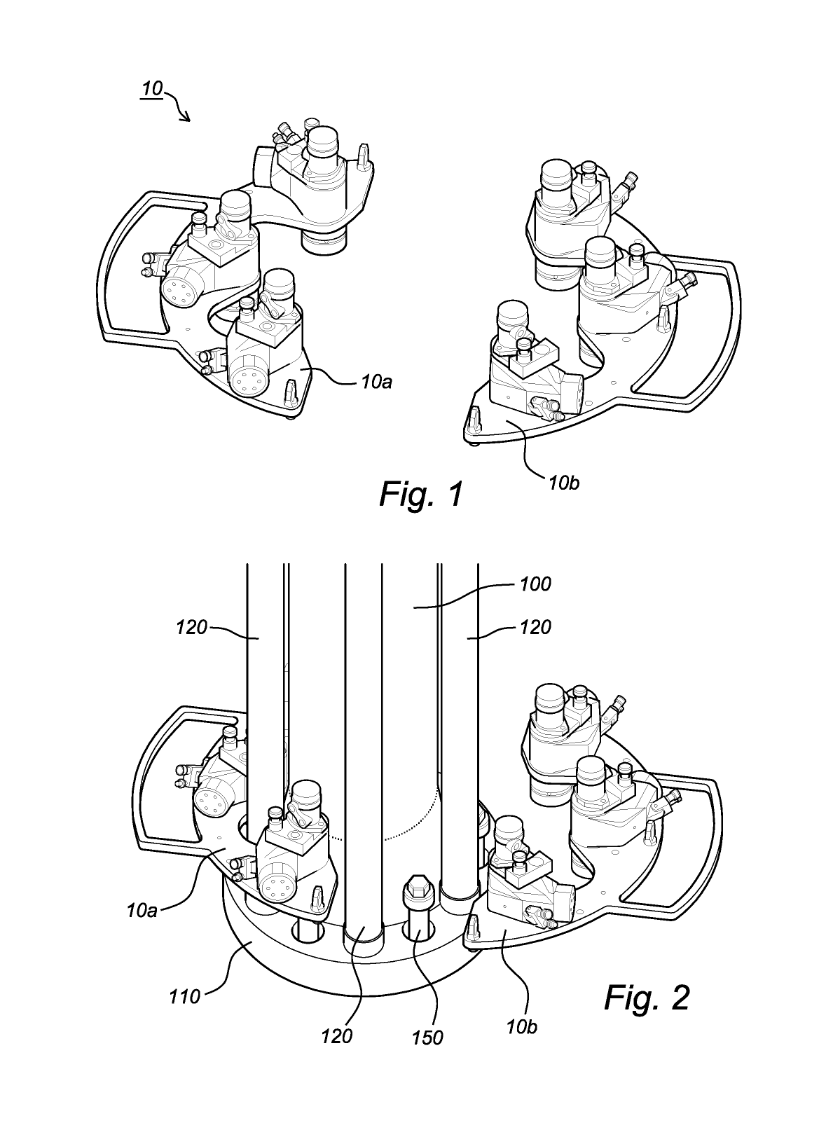

FIG. 1 shows an embodiment of the torque wrench device in accordance with the invention;

FIG. 2 shows the same embodiment as FIG. 1, when one of said tool parts has been applied to a test set-up;

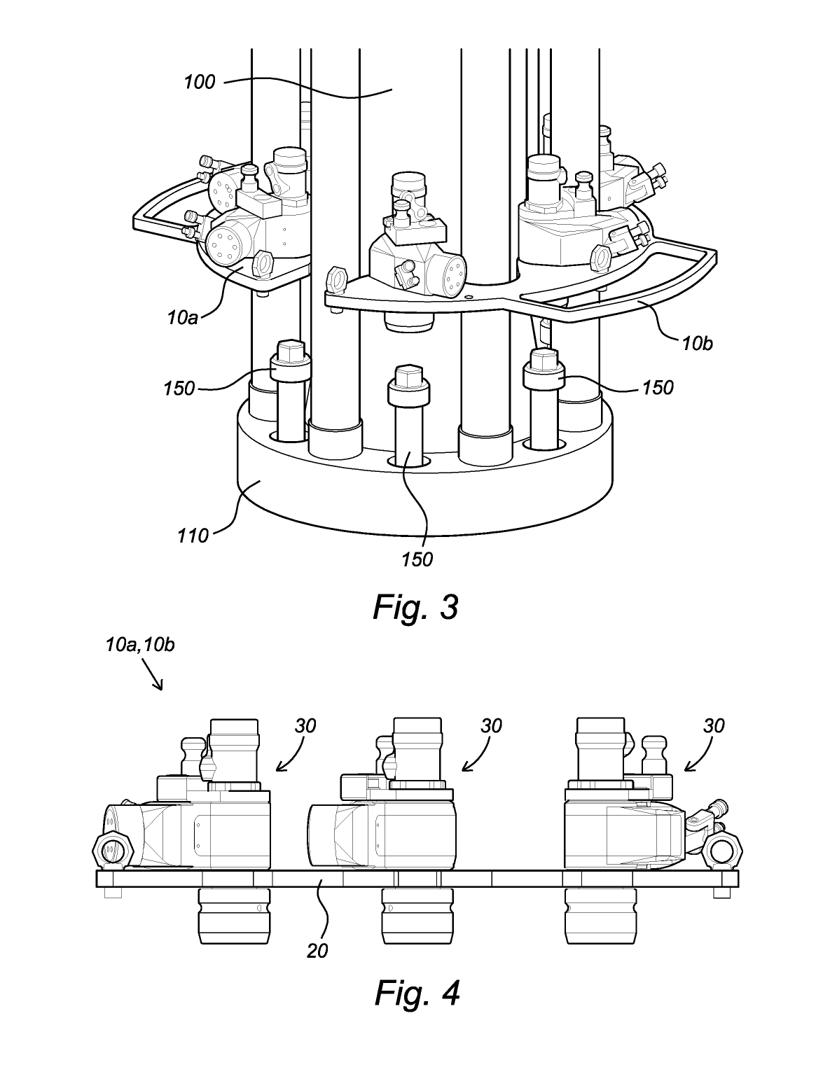

FIG. 3 shows the same embodiment as FIGS. 1 and 2, when both of said tool parts have been applied to the test set-up;

FIG. 4 shows a front-view of one of the tool parts of the embodiment of FIGS. 1 to 3,

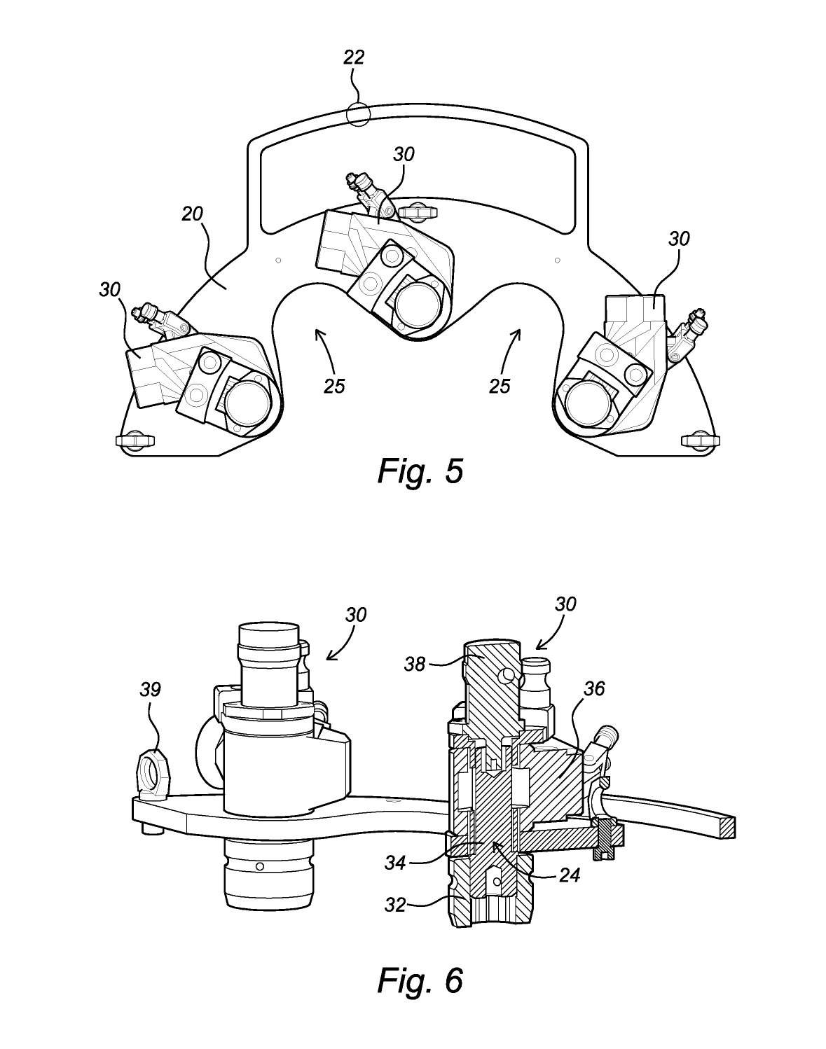

FIG. 5 shows a top-view of the tool part of FIG. 4;

FIG. 6 shows a cross-sectional view of the tool part of FIG. 4;

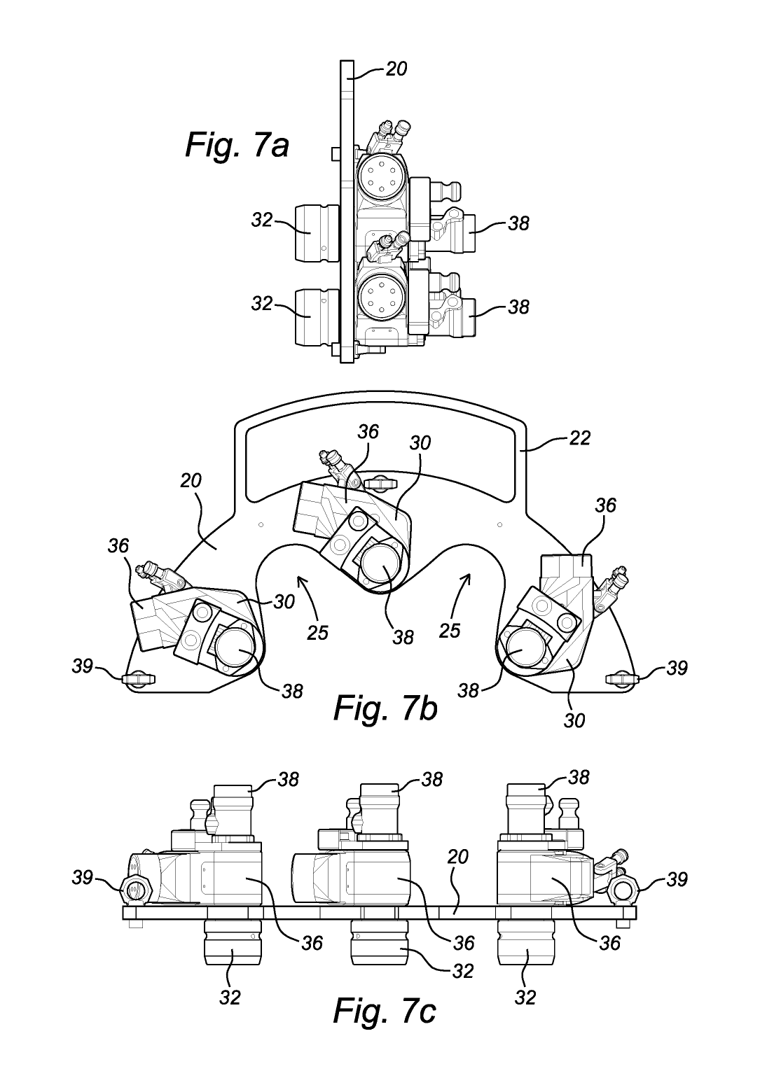

FIGS. 7a-7c show further side, top, and front-views of the embodiment of FIG. 1;

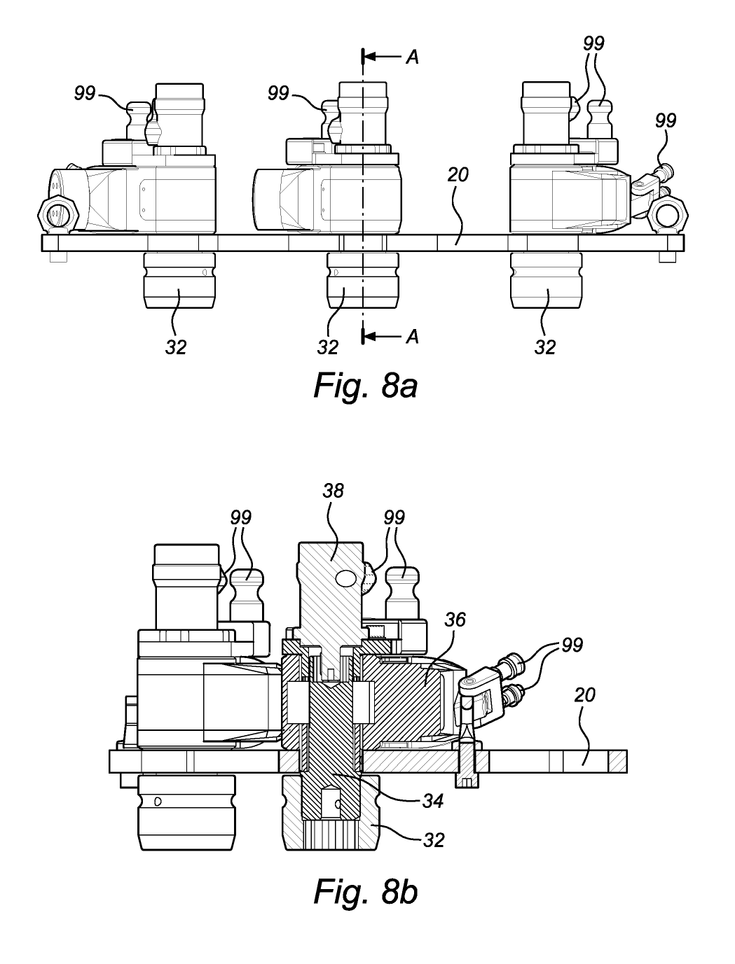

FIGS. 8a shows a similar view as FIG. 7c in a larger scale, and

FIG. 8b shows a similar view as FIG. 6 in a larger scale.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage. Throughout the Figures, similar or corresponding features are indicated by same reference numerals or labels.

FIG. 1 shows an embodiment of the torque wrench device in accordance with the invention. In this particular embodiment the torque wrench device 10 comprises of two tool parts 10a, 10b. In alternative embodiments the torque wrench device could be formed as one-part, for instance two similar parts as in FIG. 1, but then connected via a hinge at one end thereof to form a scissor structure for enclosing around a riser joint. The advantage of using two parts, however, is the reduced size and weight such that it is easier to handle for an oilrig operator or engineer.

In operational use of the torque wrench device 10 the two tool parts 10a, 10b are provided to a riser joint, one from each side. This is illustrated in FIGS. 2 and 3, wherein said tool parts are provided on a test set-up at the premises of the applicant. In FIG. 2 only one tool part 10a has been provided, whereas in FIG. 3 two tool parts have been provided. The test set-up comprises a riser joint 100 having a flange 110 for being connected to further flange (not shown) of a further riser joint (not shown). Parallel to the riser joint there are provided auxiliary pipes or tubular structures 120, such structures generally serving various purposes in oil or gas recovery. It is generally known that these structures 120 are much weaker than the main riser joint 100 and may thus not be used for forming a reaction point for torque devices. The embodiment of the invention here shown is designed such that it conveniently encloses but not touches these auxiliary pipes or tubes 120. The flange 120 of the riser joint 100 has been provided with six bolt members 150. The nuts have not been shown in the figure. It is important in riser structures that these bolts are tightened with high torques, typically in the range from 1500 to 25000 Nm.

FIG. 4 shows a front-view of one of the tool parts of the embodiment of FIGS. 1 to 3. In this view it is clearly visible that there are three torque stations 30 provided on single reaction plate 20. FIG. 5 shows the same tool part as FIG. 4, but then from the top. In this top-view some other features of this embodiment of the invention become apparent. First, the compact design must be noted. The respect torque stations 30 are all provided such that they hardly extend beyond the outer circumference of the reaction plate 20. Expressed differently, the torque stations 30 are provided such that in operational use they are all substantially above the respective bolt member 150 to which they are coupled. Second, there is shown a handle 22 that is coupled to the reaction plate and allows for convenient handling by an operator or engineer on a platform. Finally, the reaction plate 20 has been provided with indentations 25 which are designed to receive the earlier discussed auxiliary pipes or tubes 120.

FIG. 6 shows a cross-sectional view of the tool part of FIG. 4. Some internal parts of the torque station 30 are visible in this figure. First, there is shown the socket 32 for receiving said bolts. There is also shown a tool drive 34 that is mechanically coupled to said socket 32 for driving the socket. The respective torque station 30 further comprises a wrench tool 36 configured for torqueing the tool drive, and a spinning tool 38 configured for spinning the tool drive 40. The respective torque station 30 combines conventional tools as such, albeit that the inventor is the first to apply such compact conventional tools in this application. As it comes down to implementing a torque station 30 that is suitable for being used in the invention, there exist many implementations and variations. However, designing a torque station 30 comprising both a wrench tool (for the high torque) as well as a spinning tool (for the high spinning) as such, is considered to be known to the person skilled in the art. In a possible implementation the following hydraulic wrench tool 36 could be used to build the invention:

The Avanti 20 offered by HYTORC.

Furthermore, for the spinner tool 38 the following hydraulic tool could be used:

The “OMM100 Motor” offered by DAN FOSS.

The hydraulic system coupled to the wrench tool (torque tool) and spinner tool preferably comprises two independent hydraulic systems, because the wrench tool may need a certain minimum piston volume in order to be able to deliver the required torque. In the prior art solution all hydraulic pressures are supplied from the Drilling Rig's internal hydraulic system, called “Ringline”, which typically has a maximum pressure of 200 bar. The inventors have developed a pressure booster system, which generates a maximum of 700 bar, wherein the pressure can be adjusted between 100 bar and 700 bar. Now, that measure made it possible to use standard 700 bar torque tools, which require a much smaller piston volume at the same torque requirements. In other words, this measure results in an even more compact solution. The spinner tool system does not require such high torque and may be operated on the standard drilling rig hydraulic pressure of maximum 200 bar. The hydraulic systems are controlled from a mobile control box.

Another aspect of the invention that is illustrated in FIG. 6 is the hooks 39 that are mounted on the reaction plate 20. In order to facilitate handling of the torque wrench device of the invention it may be hung via said hooks 39 onto a spring balancer to cancel its weight for a large part. This facilitates handling by an operator or engineer.

FIGS. 7a-7c show further side, top, and front-views of the embodiment of FIG. 1. These figures have been included for further illustration of the embodiment as illustrated in FIGS. 1 to 6.

FIGS. 8a shows a similar view as FIG. 7c in a larger scale. FIG. 8b shows a similar view as FIG. 6 in a larger scale. Apart from the further illustration as mentioned for FIGS. 7a-7c, FIGS. 8a and 8b serve to illustrate the hydraulic interface 99 of the torque wrench device 10. Each of said hydraulic tools 36, 38 has a hydraulic inlet and an hydraulic outlet forming this hydraulic interface 99. Typically, a couple of hydraulic hoses are connected to these inlets and outlets, which are connected to a hydraulic control unit (not shown). This hydraulic control unit can be placed at a safer distance from the riser, i.e. outside the so-called red zone. All these aspects contribute to a very compact and lightweight solution in comparison to the earlier-described prior art solution. The inventors have built a prototype, of which each tool part only weighs 105 kg, such weight being within reach of the human carrying capability (thus portable), and definitely when two engineers or operators are carrying the tool. Furthermore, it is important to note that the inventors are the first to come up with a multi-bolt or nut torque wrench device that is mobile, which is not the case for the bulky prior art solution.

Even though the embodiment discussed with respect to the figures is suitable for spinning and torqueing bolts or bolt members, the invention is also applicable to a torque wrench device for spinning and torqueing nuts or nut members.

In another variation of the invention there is a different number of torque stations provided per tool part of torque wrench device.

The invention is not necessarily limited to the application field of risers in off-shore drilling system. The invention may be applied in any technical field, where multiple bolts are used to connect mechanical members together.

1. Multi-bolt or nut torque wrench device (10, 10a, 10b) for installing or removing a plurality of threaded bolt or nut members (150) on a riser (100) of a rig, the device comprising:
a reaction plate (20);
a plurality of torque stations (30) mechanically coupled to the reaction plate (20) and configured for receiving one of said bolt or nut members (150) in operational use; and
in operational use, each torque station (30) applies reaction force directly and only to the reaction plate (20), and in that the reaction plate (20) and said plurality of torque stations (30) are configured to be located substantially at an upper side of a respective flange (110) of a respective riser joint to be coupled or decoupled from a further riser joint in operational use, such that said torque wrench device (10, 10a, 10b) is configured for resting substantially on said plurality of threaded bolt or nut members (150) in operational use.

2. Device according to claim 1, wherein each one of said plurality of torque stations (30) comprises:
a socket (32) for receiving a bolt or nut member (150);
a tool drive (34) mechanically coupled to the socket (32) for driving the socket (32);
a wrench tool (36) configured for torqueing the tool drive (34);
a spinner tool (38) configured for spinning the tool drive (34), and
a hydraulic interface (99) for being coupled to a hydraulic controller for selecting one of said tools (36, 38) in operational use.

3. Device according to claim 2, wherein said wrench tool (36) and said spinner tool (38) are hydraulic tools.

4. Device according to claim 2 wherein said wrench tool (36) and said spinner tool (38) are standard lightweight hydraulic tools.

5. Device according to claim 3 wherein the wrench tool (36) and the spinner tool (38) are driven by independent hydraulic systems.

6. Device according to claim 2, wherein the wrench tool (36) is driven by a hydraulic system operating at a pressure selected from the group consisting of higher than 200 bar, higher than-500 bar, and higher than 700 bar.

7. Device according to claim 1, wherein said reaction plate (20) comprises lightweight material.

8. Device according to claim 1, wherein the reaction plate (20) is provided with a plurality of through-holes (24) through which said plurality of torque stations (30) extend and operate.

9. Device according to claim 1, wherein each one of said plurality of torque stations (30) has a respective torque driving axis of operation that coincides with a rotation axis of said respective bolt or nut member (150) to which it is coupled in operational use.

10. Device according to claim 1, wherein the reaction plate (20) is shaped to receive a member selected from the group consisting of a riser (150) within and a further pipe or pipes (120) that run parallel to the riser (100).

11. Device according to claim 10, wherein the shape of the reaction plate (20) includes a number of indentations (25) having a size and location complying with said further pipe or pipes (120).

12. Device according to claim 1, wherein said torque wrench device (10, 10a, 10b) is configured in size, shape and weight for being portable by humans.

13. Device according to claim 1, wherein the torque wrench device (10, 10a, 10b) is configured to be placed on top of the bolt or nut members, in operational use.
